(19) United States
(12) Patent Application Publication
(10) Pub. No.: US 2017/0114501 A1
(43) Pub. Date: Apr. 27, 2017

(54) USE OF ZIRCONIUM-CONTAINING ADDITIVE COMPOSITIONS

(71) Applicant: KURITA WATER INDUSTRIES LTD., Tokyo (JP)

(72) Inventors: Rongbiao WANG, Limburgerhof (DE); Jochen STEIN, Ludwigshafen (DE); Rudolf LUNKENHEIMER, Wackernheim (DE); Michael NEUMANN, Mannheim (DE)

(21) Appl. No.: 15/039,641

(22) PCT Filed: Jan. 9, 2015
(86) PCT No.: PCT/EP2015/050330

§ 371 Date: May 26, 2016

(30) Foreign Application Priority Data
Jan. 10, 2014 (EP) 14150810.1

(51) Int. Cl. D21H 19/54; D21H 19/64; D21H 17/28; D21H 19/34; C09J 103/02; C09J 11/04

(52) U.S. Cl. CPC D21H 19/54; C09J 103/02; C09J 11/04; D21H 17/28; D21H 19/34; D21H 19/64

(57) ABSTRACT

The invention relates to the use of an additive composition in the form of an aqueous solution or dispersion having a solids content in the region of 5 to 75% in wt. with respect to the total weight of the additive composition, obtained according to a method consisting of mixing the components a) and b) in an aqueous medium, wherein a) is selected from sodium zirconium carbonate, potassium zirconium carbonate, ammonium zirconium carbonate and mixtures thereof, b) is selected from at least one ortho-phosphate, at least one condensed phosphate, salts thereof and mixtures as additives in starch glue.

### BACKGROUND OF THE INVENTION

The present invention relates to the use of zirconium-containing additive compositions in starch glue and to the use of thus additized starch glues in the manufacture of paper, cardboard, corrugated fiberboard and paper sleeves.

### PRIOR ART

Starch glues, or starch pastes, are known in the prior art as aqueous adhesive compositions comprising starch and/or starch derivatives with or without dextrins and further additives. Starch, starch derivatives and dextrins are raw materials which are inexpensive, readily available and renewable. Starch glues are important adhesives for paper-based products and other porous substrates in many industrial applications, in particular in the packaging industry. Starch glues are used in paper processing for adhering together the final paper-based products, for example in the manufacture of cardboard sleeves or corrugated fiberboard. A particular requirement of starch glues is tack, i.e., a high level of adherence between the adherend materials within a short time of contact in order to ensure a high rate of processing speed and obviate long drying times. Starch glues are further expected to have long-term processability/stability, i.e., the starch glue shall for example not thicken or increase in viscosity and maintain a consistent as well as reproducible quality for a very long period.

The prior art discloses various processes for producing starch glue. For instance, starch and/or starch derivatives are cooked until a gelatinizing reaction occurs; it is also possible to use specifically modified, cold water soluble starch derivatives.

A further possible way to produce starch glues is the Stein-Hall process, wherein a small proportion of a starch is gelatinized into a high-viscosity paste. This high-viscosity paste is known as primary starch or carrier starch. The remaining, larger proportion of the starch, the so-called secondary starch, is in the form of undigested starch granules suspended in water. In the Stein-Hall process, the secondary starch comprising the undigested starch granules forms a suspension in the high-viscosity primary starch. Borax and alkali are typically also added in the production of starch glue in order to increase the viscosity and the tack and to reduce the gelatinization temperature of the secondary starch. The functioning of this two-phase Stein-Hall concept implies that the secondary starch does not gelatinize until exposed to a particular temperature during further processing. For example, the temperature of heated rolls of a processing machine is transferred to paper plies and thus also to the starch glue and the secondary starch between the paper plies to form a strong bond between the paper plies.

The Minocar process and the no-carrier process are further known processes for producing starch glues in the corrugated fiberboard area. The processes all involve the use of starch and its derivatives as main constituent of starch glue. Starch glues further comprise additives for controlling the rheological properties and the tack and also alkali for establishing the gel point. The additives used are mainly borax in powder form or water-soluble and dispersed boric acid salts.

The problem with starch glues is the reorganization of the starch molecules also called retrogradation. The increased viscosity due to the formation of network structures makes the processing of starch glue very difficult or even impossible. Starch glues prone to fast retrogradation thus lack long-term stability.

Starch glues are starch-based adhesives which are required in the manufacture of corrugated fiberboard. Corrugated fiberboard is a glued lightweight construction in paper, the quality and stability of which are appreciably influenced by the type of adhesive material used and the stringency of the adhesive bonding. Starch glue is used in the adhesive bonding to bond the flat sheets of raw paper to the corrugated sheets. Corrugated fiberboard is produced in a process where the initial step is to corrugate a sheet of paper between hot fluted rolls. Starch glue is then applied to the tips of the flutes of the corrugated sheet on one side thereof and the corrugated sheet is adhered to a planar sheet of paper. The product formed by adhering a flute to a planar sheet of raw paper is known as single-faced corrugated fiberboard. In single-wall corrugated fiberboard, one flute is positioned between two sheets of paper and in double- or triple-wall corrugated fiberboard there are two or, respectively, three corrugated sheets positioned between planar sheets of raw paper. It is an absolute necessity of the manufacturing process for corrugated fiberboard that bond formation between the fiber surfaces by the starch glue take place at a high rate of speed. It is accordingly very important that starch glue parameters such as viscosity, water retention and inner cohesion be optimally aligned in order to ensure satisfactory application of the adhesive, even at high processing speeds, a high rate of speed for the formation of the adhesive bonding and a corresponding stringency for the adhesive bonding.

A high rate of speed for the gelatinization and the adhesive bonding is augmented by a high temperature of application and by the influence of alkali such as, for example, NaOH and by boron compounds, such as borax or ethanolamine salts of boric acid (Prodac®, from Ziegler & Co. GmbH) in the adhesive composition. Borax works to control the stability, rheology and surface wettability of the starch glue during production and processing. The amounts of borax vary as a function of the applications and the starch variety in the range from about 0.5% to 20% bone-dry weight, based on starch usage.

As soon as borax is added to the mixture of starch and alkali under agitation and heating, the viscosity rises and the starch glue obtained has long-term stability. However, borax and boric acid are known to be “toxic for reproduction (FD) 18” and so are controversial raw materials which the corrugated fiberboard industry or else the manufacturers of sleeves are keen to replace. Borax and boric acid have been included in the candidates list of the European Chemical Agency (ECHA) as SVHC (substances of very high concern) since 2010. Of late, adhesive producers and processors are limiting borax usage to about 7%.

The toxicity of boron compounds has motivated numerous attempts to find alternative additives.

JP 2004-002656A describes a corrugated fiberboard starch paste comprising water-soluble aluminum and/or zirconium and/or titanium compounds as adherence enhancers as well as starch and starch-swelling agents. The water-soluble metal compounds mentioned are not universally usable and/or only efficacious at very high concentrations, which greatly curtails their usage from an economic viewpoint. Moreover, acidic aluminum salts such as aluminum nitrates, sulfates or chlorides cannot be used for the abovementioned processes such as Stein-Hall, Minocar or no-carrier. Basic aluminum compounds such as sodium aluminate for example do not deliver the necessary starch glue parameters regarding, for example, gelation point, viscosity increase, viscosity stability or tack. Tack enhancement is poor with zirconium salts such as ammonium zirconium carbonate; usage of zirconium salts with corn starch is inadvisable.

JP2005-226011A describes a starch-based corrugated fiberboard adhesive comprising thickening agents (coagulants) such as, for example, polymers having low cationic activity, polymers having a weak anionic charge or nonionic polymers and thickening auxiliaries such as aluminate or silicate and crosslinking agents for starch such as epoxy resins, ammonium zirconium carbonate or formaldehyde resins. However, three groups of substances are evidently needed to establish the parameters of the starch glue and obtain an adhesive that is actually fit-for-purpose. The greater the complexity of the system, the more liable it is to go wrong; alternatives to a 3 component system are therefore desirable. In any case, the tack of these systems is insufficient despite the use of various polymers.

JP2008024876A describes a corrugated fiberboard adhesive comprising nongelated starch, polyvinyl alcohol having a saponification number of 70% to 100%, a water-soluble metal component selected from the group of water-soluble aluminum, titanium and zirconium compounds, and an alkaline component. Here the assistance of a polymer is needed to produce a suitable starch glue. In addition to the inconvenience of the multi-component systems, it must be noted that polyvinyl alcohol is a pricey raw material and so its use appears to be questionable from a commercial viewpoint, in particular since its concentration relative to nongelated starch is very high at not less than 5%.

There is accordingly an urgent need to find an additive composition for starch glues used in the manufacture of paper, cardboard, corrugated fiberboard and/or paper sleeves which establishes important parameters such as viscosity, gelation point, tack, etc., in order that boron-containing additives may be replaced from technical and qualitative viewpoints. The additive composition should further be toxicologically unconcerning, in contradistinction to boron-containing additives.

It is an object of the present invention to provide a starch glue additive which avoids the aforementioned disadvantages. In particular, the additive composition shall not be toxic and shall endow a starch glue with high tack. A thus additized starch glue should provide a strong durable bond between paper surfaces and improve the quality of the adhesive bonding. A thus additized starch glue should further have long-term stability and processability.

### SUMMARY OF THE INVENTION

It has now been found that, surprisingly, this object is achieved by a zirconium-containing additive composition defined hereinbelow. Advantageously, the additive composition of the present invention does not require any boron salts and is not toxic for the environment. A further advantage is the high tack of a starch glue comprising the additive composition of the present invention, ensuring a high rate of speed and consistency in the adhesive bonding of paper, cardboard, paperboard, corrugated fiberboard products and paper sleeve products. A starch glue comprising the additive composition of the present invention is stable for a long period in that it exhibits no or but a minimal change in viscosity during this period, providing a wide processing time window.

The invention accordingly provides the method of using an additive composition in the form of an aqueous solution or dispersion having a solids content ranging from 5 to 75 wt % based on the overall weight of the additive composition, obtainable by a process comprising mixing constituents a) and b) in an aqueous medium wherein a) is selected from sodium zirconium carbonate, potassium zirconium carbonate, ammonium zirconium carbonate and mixtures thereof, b) is selected from at least one ortho-phosphate, at least one condensed phosphate, their acids and mixtures, as additive in starch glue.

The invention also provides the method of using the additive composition in solid form, in particular in the form of a powder of the additive composition, as an additive in starch glue.

The invention also provides a process for producing an additive composition in the form of an aqueous solution or dispersion having a solids content in the range from 5 to 75 wt %, based on the overall weight of the additive composition, obtainable by a process comprising mixing at least one constituent a) with at least one constituent b) in an aqueous medium, wherein said constituent
a) is selected from sodium zirconium carbonate, potassium zirconium carbonate, ammonium zirconium carbonate and mixtures thereof,
and said constituent
b) is selected from at least one ortho-phosphate, at least one condensed phosphate, their acids and mixtures.

The invention also provides a process for producing an additive composition in solid form, which process comprises mixing at least one constituent a) with at least one constituent b) in an aqueous medium,

wherein said constituent a) is selected from sodium zirconium carbonate, potassium zirconium carbonate, ammonium zirconium carbonate and mixtures thereof,
and said constituent b) is selected from at least one ortho-phosphate, at least one condensed phosphate, their acids and mixtures and drying the aqueous additive composition.

The invention further provides a process for producing an additive composition in solid form, which process comprises mixing at least one solid component a) selected from sodium zirconium carbonate, potassium zirconium carbonate, ammonium zirconium carbonate and mixtures thereof with a solid component b) selected from at least one ortho-phosphate, at least one condensed phosphate, their acids and mixtures.

The invention also provides the solid additive compositions obtainable by this process.

The invention further provides a polysaccharide composition, in particular a solid polysaccharide composition, which is suitable for producing starch glue and which contains at least one customary starch glue polysaccharide constituent selected from starch, starch derivative, dextrin and mixtures thereof, as well as an additive composition which is in accordance with the present invention and contains at least one ortho-phosphate.

The invention further provides the method of using a polysaccharide composition of this type in the manufacture of starch glue.

The invention further provides the method of using a polysaccharide composition of this type in the manufacture of paper, cardboard, paperboard, corrugated fiberboard, paper sleeves.

The invention further provides a starch glue which contains a polysaccharide composition of the present invention.

The invention further provides the method of using a starch glue of the present invention, containing the additive composition of the present invention, in the manufacture of paper, cardboard, paperboard, corrugated fiberboard and paper sleeves.

The additive composition used in the present invention has the following advantages:
A high level of tack for any starch glue comprising the additive composition of the present invention to ensure a high rate of consistency and speed in the adhesive bonding of paper-based products, as for example in the manufacture of corrugated fiberboard or cardboard sleeves.
A high level of stability for the starch glue comprising the additive composition of the present invention, i.e., the starch glue has a wide processing time window in that it exhibits no or but a minimal change in viscosity during a period needed to process the starch glue.
The additive composition of the present invention is an aqueous single-component system and so it is very user-friendly, simple to handle and convenient to meter.
The additive composition of the present invention is not toxic for the environment,
The additive composition of the present invention does not contain any toxic substances or substances listed in the ECHA candidate list.
The additive composition of the present invention is inexpensive to produce from commercially available raw materials.

### DETAILED DESCRIPTION OF THE INVENTION

One preferred embodiment of the invention is a starch glue comprising such an additive composition, wherein the overall amount of constituent a), reckoned as ZrO₂ content, and constituent b), reckoned as pure substance, relative to the polysaccharide constituents of the starch glue is in the range from 0.0002 to 0.05, preferably in the range from 0.0005 to 0.04, more preferably in the range from 0.001 to 0.02.

In particular, the aqueous additive composition is present in such a starch glue at from 0.7 to 4 wt % based on the starch fraction of the starch glue as commercial product.

In particular, the starch glue comprises a polysaccharide composition additized according to the present invention, wherein the overall amount of constituent a), reckoned as ZrO₂ content, and constituent b), reckoned as pure substance, relative to the polysaccharide constituents of the starch glue is in the range from 0.0002 to 0.05, preferably in the range from 0.0005 to 0.04, more preferably in the range from 0.001 to 0.02.

In the context of the present invention, starch glue is an at least partly gelatinized adhesive comprising a polysaccharide constituent.

In the context of the present invention, solids content is determined by drying an approximately 1 g sample at 105° C. for 2 h in accordance with DIN EN ISO 787-2. The weight of solids at the end is reported as a weight percentage relative to the original sample weight.

In the context of the present invention, zirconium carbonate is to be understood as referring to sodium zirconium carbonate, potassium zirconium carbonate, ammonium zirconium carbonate and their mixtures. In particular, sodium zirconium carbonate and potassium zirconium carbonate are to be understood as referring to the aqueous solutions and aqueous dispersions of these compounds as well as to the compounds themselves. These substances are described for example in the literature under A. Veyland et al., HeIv. Chim. Acta, 83, 414, (2000).

ortho-Phosphates are salts of (ortho)phosphoric acid H₃PO₄. Since said phosphoric acid has three acidic protons, ortho-phosphates include not only primary phosphates, which are also known as dihydrogenphosphates and in which the phosphate is present as H₂PO₄⁻ anion; secondary phosphates, which are also known as hydrogenphosphates and in which the phosphate is present as HPO₄²⁻ anion; but also tertiary phosphates, in which the phosphate is present as PO₄³⁻ anion. ortho-Phosphates are particularly alkali metal phosphates, alkali metal hydrogenphosphates, alkali metal dihydrogenphosphates, alkali metal ammoniumhydrogenphosphates, ammonium hydrogenphosphates and ammonium dihydrogenphosphates.

In the context of the present invention, condensed phosphates are phosphates derivable from acidic salts of orthophosphoric acid by condensation, as for example by pronounced heating. Examples thereof are metaphosphates having the general empirical formula (M′PO₃)ₙ, diphosphates and higher polyphosphates having the general empirical formula M′ₙ₊₂PₙO₃ₙ₊₁ and M′ₙH₂PₙO₃ₙ₊₁ respectively, where M′ is a monovalent cation and n is ≧2, for example a number from 2 to 100. Condensed phosphates include not only the full salts but also the acidic salts with the preferred cations sodium, potassium and ammonium. The term “condensed phosphate” also comprehends the free acids of the condensed phosphates, although they are generally not preferable by reason of their poor availability.

In the context of the present invention, mixing in an aqueous medium is to be understood as meaning the mixing of two aqueous constituents, the mixing of a solid constituent and an aqueous constituent and the mixing of two solid constituents in an aqueous medium.

In one preferred embodiment, the concentration of zirconium in the additive composition, reckoned as ZrO₂ content, ranges from 0.1 to 30 wt %, preferably from 0.2 to 20 wt %, based on the overall weight of the additive composition.

In one preferred embodiment, the additive composition comprises a weight ratio of zirconium, reckoned as ZrO₂ content, to said constituent b), reckoned as pure substance, in the range from 0.1 to 20, preferably in the range from 0.2 to 10, more preferably in the range from 0.3 to 5.

In one preferred embodiment, the aqueous solution or dispersion has a pH above 6, preferably above 8, in particular the aqueous solution or dispersion comprising the composition has a pH in the range from >pH 6 to pH 14 and specifically in the range from >pH 8 to pH 13.

In preferred embodiments, constituent b) is selected from: ortho-phosphates, such as the aforementioned salts of the formulae M₃PO₄, M₂HPO₄ and MH₂PO₄, where M is sodium, potassium or ammonium and similarly the hydrates of the compounds and their mixtures, diphosphates, oligophosphates, polyphosphates and their acids, in particular from sodium, potassium or ammonium salts of diphosphates, triphosphates, tetraphosphates, pentaphosphates, hexaphosphates and higher oligo- and polyphosphates having on average >6 to 100 phosphorus atoms, for example sodium tripolyphosphate, potassium tripolyphosphate, ammonium tripolyphosphate, sodium hexametaphosphate, potassium hexametaphosphate or ammonium hexametaphosphate, and also metaphosphates, in particular sodium, potassium or ammonium trimetaphosphates, trisodium trimetaphosphate, sodium tetrametaphosphate, potassium tetrametaphosphate, and also mixtures thereof. Preferred constituents b) are ortho-phosphates and their mixtures with one or more condensed phosphates. Further preferred constituents b) are polyphosphates having 2 or 3 phosphorus atoms and metaphosphates having 3 phosphorus atoms, in particular their sodium and potassium salts.

In one particularly preferred embodiment, the composition of the present invention contains at least one ortho-phosphate, in particular exactly one ortho-phosphate, which is preferably selected from compounds of the formula M₃PO₄, M₂HPO₄ and MH₂PO₄, where M is sodium, potassium or ammonium. Examples thereof are Na₃PO₄, K₃PO₄, Na₂HPO₄, K₂HPO₄, NaH₂PO₄, KH₂PO₄, Na(NH₄)HPO₄, (NH₄)₂HPO₄, (NH₄)H₂PO₄, similarly the hydrates of the compounds and their mixtures.

In one particularly preferred embodiment, component b) consists of one or more of the aforementioned ortho-phosphates, in particular of one of the aforementioned ortho-phosphates.

In one preferred embodiment, the additive composition further comprises a constituent c) in at least one hydroxycarboxylic acid, for example tartaric acid, malic acid, lactic acid, glycolic acid, gluconic acid, citric acid, and/or salts of at least one hydroxycarboxylic acid, in particular sodium salts, potassium salts, ammonium salts, mixtures of the aforementioned hydroxycarboxylic acid(s) and their salt(s). In particular, constituent c) is tartaric acid or a salt of tartaric acid.

In one preferred embodiment, the additive composition further comprises a constituent d) in at least one di- or polycarboxylic acid other than amino acids and hydroxycarboxylic acids, in particular oxalic acid, maleic acid, malonic acid, succinic acid, itaconic acid and/or salts of the at least one di- or polycarboxylic acid, in particular sodium salts, potassium salts, ammonium salts, mixtures of the aforementioned carboxylic acid(s) and/or their salt(s).

In one preferred embodiment, the additive composition further comprises a constituent e) in at least one amino acid, in particular glycine, glutamic acid, glutamine, aspartic acid, asparagine, ethylenediaminetetraacetic acid (EDTA), iminodisuccinate, N,N-bis(carboxymethyl)-L-glutamate, N,N-bis(carboxymethyl)alanine sodium salt, N,N-bis(2-hydroxyethyl)glycine and/or salts of the at least one amino acid, in particular sodium salts, potassium salts, ammonium salts, mixtures of the aforementioned amino acid(s) and/or their salt(s).

In one preferred embodiment, the additive composition further comprises a constituent f) in at least one phosphonic acid, in particular phosphonic acid, 1-hydroxyethane-1,1-diphosphonic acid, am inotris(methylenephosphonic acid), 2-phosphonobutane-1,2,4-tricarboxylic acid (PBTC), diethylenetriaminepenta(methylenephosphonic acid) (DTPMP), and/or salts of the at least one phosphonic acid, in particular sodium salts, potassium salts, ammonium salts, mixtures of the aforementioned phosphonic acid(s) and/or their salt(s).

In one preferred embodiment, the additive composition further comprises a constituent g) in at least one polyol, in particular ethylene glycol, glycerol, sorbitol, inositol, mono- and disaccharides, such as glucose or sucrose, mixtures thereof.

In one preferred embodiment, the additive composition further comprises a constituent h) in at least one alkanolamine, in particular monoethanolamine, diethanolamine, triethanolamine, mixtures thereof.

In one preferred embodiment, the additive composition further comprises a constituent i) in at least one aluminate, in particular sodium aluminate, potassium aluminate, mixtures thereof.

In the context of the present invention, aluminates are compounds of the general formula MAI(OH)₄, where M is sodium or potassium. Sodium aluminate and potassium aluminate are commercially available and comprise sodium hydroxide and potassium hydroxide, respectively, in excess for stability reasons. Said aluminates may comprise an additional stabilizer such as, for example, one or more substances of components c), e) and/or g) such as, for example, sorbitol, gluconic acid or tartaric acid. The molar ratio of Na/AI is for example up to 1.7 in a commercially available sodium aluminate solution and up to 1.3 in a commercially available sodium aluminate powder. Aluminates having higher molar ratios of alkali metal to aluminum are also usable for the additive composition of the present invention.

In one preferred embodiment, the molar ratio of aluminate, reckoned as Al₂O₃ content, to zirconium, reckoned as ZrO₂ content, in the additive composition is in the range from 0 to 10 or 0.1 to 10, preferably in the range from 0 to 5 or 0.2 to 5, more preferably in the range from 0 to 1 or 0.3 to 1.

In a further embodiment, the additive comprises at least one of the further constituents c) to i) or a combination of the further constituents c) to i).

In one preferred embodiment, the weight ratio of said one or more further constituents c) to h), reckoned as pure substance, to zirconium, reckoned as ZrO₂ content, in the additive composition is in the range from 0 to 10 or 0.1 to 10, preferably in the range from 0 to 5 or 0.2 to 5, more preferably in the range from 0 to 3 or 0.3 to 3.

Preference is given in particular to such substances c) to h) as act as ligands to constituent a).

In the context of the present invention, ligands are substances capable of forming a complex or coordination compound with the zirconium. The complexes may comprise one or more ligands and one or more central atoms. The ligands in these complexes may be the same or different. The aforementioned substances may be bound as monodentate or polydentate ligands, in which case polydentate ligands are preferable. The “denticity” (dentate-ness) refers to the number of possible bonds. The ligands are preferably selected from hydroxycarboxylic acids, carboxylic acids, amino acids, phosphonic acids, alkanolamines, salts of said acids, salts of said amines, polyols, mixtures thereof.

In one preferred embodiment, the additive composition is an aqueous solution obtainable by mixing an aqueous solution of potassium zirconium carbonate with sodium trimetaphosphate and/or potassium trimetaphosphate.

In a further preferred embodiment, the additive composition is an aqueous solution obtainable by mixing an aqueous solution of potassium zirconium carbonate with sodium tripolyphosphate and/or potassium tripolyphosphate.

In a particularly preferred embodiment, the additive composition is an aqueous solution obtainable by mixing an aqueous solution of potassium zirconium carbonate with a sodium orthophosphate and/or a potassium orthophosphate.

In one preferred embodiment, constituents c) to h) are ligands selected from citric acid, glycine, DTPMP, EDTA, oxalic acid, sorbitol, PBTC, tartaric acid.

In one preferred embodiment, the additive composition is in solid form, in particular in the form of a powder obtainable by drying an aqueous additive composition.

In one preferred embodiment, the additive composition is in solid form, in particular in the form of a powder. Particular preference is given to solid additive compositions obtainable by mixing solid potassium zirconium carbonate with at least one ortho-phosphate selected from sodium phosphate and potassium phosphate or by drying an aqueous solution obtainable by mixing an aqueous solution of potassium zirconium carbonate with a sodium orthophosphate and/or a potassium orthophosphate.

Preferred embodiments of the invention also relate to solid compositions comprising polysaccharide which include at least one additive composition of the present invention in solid form or in aqueous form.

In addition to additive composition A of the present invention, these compositions comprise at least one polysaccharide constituent customary for the manufacture of starch glues. Suitable polysaccharide constituents are, in particular, native starch and modified starches, including partial hydrolyzates of starch such as dextrins. Suitable native starches are, in particular, starches from wheat, corn, potato, tapioca, rice or peas including waxy starches such as waxy maize starch or Potato Amylopectin®.

Starch glues are produced in particular similarly to the prior art processes mentioned at the beginning. For instance, starch and/or starch derivatives are cooked until a gelatinizing reaction occurs; it is also possible to use specifically modified, cold water soluble starch derivatives, or else the Stein-Hall process can be used. Existing processes for producing starch glues further include the Minocar process or the no-carrier process. The additive composition of the present invention may be admixed to the starch glue for example. A further possibility is to admix the additive composition of the present invention to starch and/or starch derivatives and/or dextrins and then produce a starch glue.

The starch glues of the present invention are usable in a conventional manner in the manufacture of paper-based products, for example paper, cardboard, paperboard, corrugated fiberboard and paper sleeves, for adhesive bonding. When starch glue is used in the adhesive bonding particularly between individual plies of paper in the paper-based products, a strong bond develops between the plies of paper to produce paper-based products that are stable. The starch glues of the present invention are therefore particularly useful in the manufacture of corrugated fiberboard and paper sleeves.

### ABBREVIATIONS

The following abbreviations are used:
SL starch glue
SL-1 corn starch (C*Size 03453) from Cargill
SL-2 wheat starch from Cargill
SL-3 Mylbond®210, modified wheat starch from Tereos Syral
SL-4 Mylbond®210, modified wheat starch from Tereos Syral
SL-5 Allstarch®CWX 5, modified wheat starch from Interstarch Gesellschaft mbH
SL-6 Mylbond®210, modified wheat starch from Tereos Syral
SL-7 to SL-9 corn starch (C*Size 03453) from Cargill
Starch 1 primary starch in Stein-Hall process
Starch 2 secondary starch in Stein-Hall process
STMP sodium trimetaphosphate
STPP sodium tripolyphosphate
KZC potassium zirconium carbonate

The examples which follow illustrate the starch glue additive composition of the present invention and the process for producing the additive composition.

### EXAMPLES

### Production of Starch Glues 1 to 10 (SL-1 to SL-10)

The starch used comes for example from wheat, corn, waxy maize, potatoes, Potato Amylopectin, tapioca, rice or peas, and is used as such, without modification, or may have been chemically or enzymatically or physically modified according to the generally/commonly known processes.

The starch glue was produced in accordance with the Stein-Hall process from a mixture of a gelatinized starch, the so-called primary starch, and an ungelatinized, so-called secondary starch. The gelatinization of the primary starch was effected in a VMA-Getzmann Dispermat dissolver with a dissolver disk 6.5 cm in diameter. The water used was heated town water 1 or a mixture of town water 1 and service water 1 (service water pH: 6.9, service water conductivity: 3.6 mS/cm), initially charged to a 1 L stainless steel container. The primary starch was stirred in and, following admixture with aqueous sodium hydroxide solution quantity reported in table 1, gelatinized at the reported stirring speed, at the reported temperature and in the course of the reported time. Following admixture of further town water 2 or of a mixture of town water 2 and service water 2, the secondary starch was stirred in without clumping, the additive composition of the present invention was metered in and the mixture was stirred at the reported stirring speed for the reported period.

TABLE 1
Particulars for preparation of starch glues SL-1 to SL-10.

| | Starch glue (SL) | | | | | | | | | |
|---|---|---|---|---|---|---|---|---|---|---|
| | SL-1 | SL-2 | SL-3 | SL-4 | SL-5 | SL-6 | SL-7 | SL-8 | SL-9 | SL-10 |
| starch type | corn | wheat | Mylbond ® | Mylbond ® | Allstarch ® | Mylbond ® | corn | corn | corn | pea |
| | starch | starch | 210 | 210 | CWX 5 | 210 | starch | starch | starch | starch |
| T (° C.) of water 1 | 60 | 60 | 35 | 35 | 35 | 35 | 60 | 60 | 60 | 31 |
| town water 1 (g) | 120 | 104.29 | 157.5 | 141.5 | 168.65 | 236.58 | 160 | 160 | 160 | 188.2 |
| service water 1 (g) | — | — | — | 16 | — | — | — | — | — | — |
| Starch 1 (g) | 12.8 | 10.73 | 14.3 | 14.3 | 13.25 | 22.43 | 17.07 | 17.07 | 17.07 | 18.14 |
| NaOH 50% (g) | 5.2 | 3.18 | 2.92 | 2.92 | 2.85 | 4.38 | 6.93 | 6.93 | 6.93 | 4.22 |
| stirrer speed (rpm) | 1000 | 1000 | 4900 | 4900 | 5000 | 3000 | 1400 | 1400 | 1400 | 1400 |
| stirring time (min) | 30 | 30 | 6 | 6 | 12 | 12 | 12 | 12 | 12 | 10 |
| T (° C.) | 30 | 30 | 25 | 25 | 25 | 25 | 30 | 30 | 30 | 30 |
| town water 2 (g) | 220 | 194.12 | 166 | 66 | 121.25 | 249 | 293.33 | 261.54 | 231.35 | 244.2 |
| service water 2 (g) | — | | — | 100 | — | — | | — | 100 | — |
| starch 2 (g) | 101.2 | 89.15 | 74.7 | 74.7 | 87.5 | 109.27 | 134.93 | 167.75 | 198.55 | 148.84 |
| additive | see | see | see | see | see | table | table | table | table | table |
| composition | tables | table | tables | table | table | 8 | 7 | 7 | 7 | 14 |
| | 3, 9 | 4 | 10, 13 | 10 | 11 | | | | | |
| stirrer speed (rpm) | 1400 | 1400 | 4900 | 4900 | 5000 | 1400 | 1400 | 1400 | 1400 | 1400 |
| stirring time (min) | 30 | 30 | 6 | 6 | 15 | 8 | 8 | 15 | 20 | 10 |
| concentration of | 24.4 | 22.4 | 18.8 | 18.8 | 22.6 | 18.8 | 24.3 | 29.5 | 34.4 | 27.6¹⁾ |
| starch in wt % | | | | | | | | | | |
| (after 2 h drying | | | | | | | | | | |
| at 105° C.) | | | | | | | | | | |
| Lory viscosity (s) | 10 | 11 | 12 | 12 | 11 | 14 | 11 | n.d. | n.d. | n.d. |
| without additive | | | | | | | | | | |
| composition | | | | | | | | | | |

(¹⁾concentration of starch as commercial product, n.d.: not determined)

Table 2 hereinbelow shows compositions for the inventive additive composition and for comparative examples; the particulars are contents in weight percent. Examples 1 and 2 represent the prior art. Examples 3 to 21 show comparative examples and inventive embodiments. The aluminum and zirconium concentrations are reported as concentrations of their oxides, as is customary in the prior art. The remainder to 100% is water and carbonate except for Example 16, where an additional 2.6 wt % of NH₄⁺ cations are present.

TABLE 2
Composition of additive compositions.

| Ex- | | Aluminum | Zirconium | Tartaric | ortho- | | | potas- |
|---|---|---|---|---|---|---|---|---|
| ample | Observation | as Al₂O₃ | as ZrO₂ | acid | PO₄³⁻ | STMP | STPP | sium |
| 1 | borax | | | | | | | |
| 2 | Prodac ® | | | | | | | |
| 3 | STMP solids, | | | | 100 | | | |
| | comparator | | | | | | | |
| 4 | STPP solids, | | | | | 100 | | |
| | comparator | | | | | | | |
| 5 | aqueous solution | | 12.5 | | | | | 15.9 |
| 6 | aqueous solution | | 5 | | | 10 | | 6.4 |
| 7 | aqueous solution | | 5 | | | | 10 | 6.4 |
| 8 | powder mixture, | | 15.2 | | | 31 | | 19.3 |
| | comparator | | | | | | | |
| 9 | powder mixture, | | 15.2 | | | | 31 | 19.3 |
| | comparator | | | | | | | |
| 10 | powder additive | | 15 | | | 30 | | 19.1 |
| | composition 6 | | | | | | | |
| | spray dried | | | | | | | |
| 11 | aqueous solution | | 12.5 | 1.1 | | | | 16 |
| 12 | aqueous solution | | 4.8 | 2.3 | | 15 | | 6.1 |
| 13 | aqueous solution | | 5 | 7.6 | 3.3 | 5 | | 9.1 |
| 14 | aqueous solution | | 5 | 7.6 | 3.3 | | | 9.1 |
| 15 | aqueous solution | | 5 | 2 | | 12.5 | | 8 |
| 16* | aqueous solution | | 5 | 2 | | 12.5 | | |
| 17 | aqueous solution | 1.9 | 5 | 6.2 | 2.6 | 5 | | 10.4 |
| 18 | aqueous solution | 1.9 | 5 | 6.2 | 2.6 | | | 10.5 |
| 19 | aqueous solution | 3.8 | 5 | 8 | 3.3 | 5 | | 12.9 |
| 20 | powder, additive | 7.6 | 10 | 16 | 6.6 | 10 | | 25.8 |
| | composition 19 | | | | | | | |
| | spray dried | | | | | | | |
| 21 | aqueous solution | 1.9 | 5 | 6.2 | 2.6 | 12 | | 10.4 |

*contains 2.6% of NH₄

The raw materials used were as follows:
aqueous potassium zirconium carbonate solution with 12.5 wt % of ZrO₂, a carbonate content of 24.5 wt % and a potassium content of 15.9 wt %, prepared from basic zirconium carbonate and potassium bicarbonate,
aqueous potassium zirconium carbonate solution with 12.5 wt % of ZrO₂, a carbonate content of 21.3 wt % and a potassium content of 13.9 wt %, prepared from basic zirconium carbonate and potassium bicarbonate,
spray-dried potassium zirconium carbonate (KZC) with 22.1 wt % of ZrO₂, a carbonate content of 40 wt % and a potassium content of 28 wt %,
aqueous ammonium zirconium carbonate solution with 11.5 wt % of ZrO₂, a carbonate content of 16 wt % and an ammonium content of 5.9 wt %, prepared from basic zirconium carbonate, ammonium hydrogencarbonate and ammonia,
sodium trimetaphosphate from BK Giulini GmbH,
sodium tripolyphosphate from BK-Giulini GmbH,
potassium tripolyphosphate from BK-Giulini GmbH,
sodium dihydrogenphosphate monohydrate from Sigma Aldrich,
disodium hydrogenphosphate from BK-Giulini GmbH,
potassium dihydrogenphosphate from BK-Giulini GmbH,
dipotassium hydrogenphosphate from BK Giulini GmbH,
potassium hydrogencarbonate from Sigma Aldrich,
ammonium bicarbonate from Sigma Aldrich,
tartaric acid from UD Chemie,
aqueous potassium aluminate with 19 wt % of Al₂O₃, and
town water.

The aqueous solutions were all prepared by mixing the appropriate raw materials, generating clear to cloudy solutions. Following a standing time of at least 24 h in each case, the products were tested as additive composition. Additive compositions 8 and 9 were prepared by mixing spray-dried potassium zirconium carbonate (KZC) with sodium trimetaphosphate (STMP) or, respectively, sodium tripolyphosphate (STPP). Additive composition 10 corresponds to additive composition 6 spray dried.

Table 3 hereinbelow juxtaposes the conventional additive composition borax (additive composition from Example 1, in short: additive composition 1), the inventive additive compositions 6 and 7 and also comparative examples.

Evaluation was according to the starch glue parameters of Lory viscosity, gelation point and tack. The comparators used for this were close-to-actual-practise formulations for the boron-containing additives borax or Prodac®.

Lory viscosity is determined as the time in seconds for the starch glue to drain from a Lory LCH cup (Elcometer 2215). The starch glue to be measured is heated to 30°, introduced into a cylindrical Lory LCH cup likewise preheated to 30° C. and allowed to drain therefrom through the escape hole in the bottom of the cup, said hole having a diameter of 4 mm. As soon as the starch glue begins to flow out, a stopwatch is started. The distance between the upper rim of the cup and the tip of a cone positioned centrally in the bottom of the cup is 31 mm. As soon as the tip of the cone is no longer covered by starch glue and becomes visible, the stopwatch is stopped. The elapsed time in seconds is reported as Lory viscosity.

The gelation point of the starch glue is determined by a Cargill method. To this end, the jacket of a jacketed glass vessel is filled with completely ion-free water, which acts as heat transfer medium. The glass vessel interior is fitted with a magnetic stirbar and filled with the starch glue. The vessel is placed on a magnetic stirrer which is equipped with a heating system, and is heated up at a heating rate of 2.5° C./min under agitation. Once the gelation point is reached, the temperature tends to fall. The maximum temperature at this point is noted as the gelation point.

The stringency of the adhesive bonding is determined using, for example, the tearing test: the flat sheet in a piece of corrugated fiberboard is torn off from the corrugated sheet. The greater the extent of fiber residues remaining behind in the formally adhered places, the better the adhesive bonding was. Adhesive bonding is very good when the two sheets of paper can only be separated again with fiber tear-off.

Tack was determined as follows. Fluted paper strips having a weight of 100 g/m² and a size of 30×70 mm were heated in a thermal cabinet at 60° C. for not less than 12 h. A 50 μm manual blade coater was used to apply a starch glue quantity to all of a first specimen except for a 1 cm wide strip at one fluted paper strip end. The coating was applied at a rate of 50 g per square meter of fluted paper. A second fluted paper strip of the same size, likewise heated to 60° C., was placed on top of the coated starch glue layer in accurate registration and a roller 4 kg in weight was rolled across once. Coating and adhering the fluted paper strips took from 6 to 7 seconds. The adhered fluted paper strips were stored in a thermal cabinet at 60° C. Every 5 seconds an adhered fluted paper strip was taken from the drying cabinet and the glued-together fluted paper strips were pulled apart by hand. Thereafter, the surface of the adhesive bond now sundered was assessed for fiber tear-outs out of the surface by visual inspection. The time after removing the adhered fluted paper strip from the drying cabinet was noted when a fiber tear was detectable across the full adhered width of the previously adhered fluted paper strip. Every tack value reported in table 3 and the subsequent tables is the average of at least five individual measurements. Blade, roller and worksurface were all temperature controlled to 20-25° C. A fiber tear across the full adhered width of a previously adhered fluted paper strip after a short delay time indicates high tack.

TABLE 3
Influence of additive compositions 1 to 10 from table 2 on
Lory viscosity, gelation point and tack of corn starch glue
SL-1 from table 1.

| | | Concen- | | | |
|---|---|---|---|---|---|
| | | tration | | | |
| | Additive | based on | Lory | Gelation | |
| | composition | starch | viscosity | point | Tack at |
| Example | of Example | in % | 2215 (s) | (° C.) | 60° C. (s) |
| 22 | 1 | 1.5 | 21 | 57 | 25 |
| 23 | 3 | 2 | 10 | 56 | none |
| 24 | 4 | 2 | 9 | 56 | none |
| 25 | 5 | 1.3 | 20 | 58 | none |
| 26 | 5 | 3 | 33 | 59 | none |
| 27 | 6 | 3 | 26 | 58 | 30 |
| 28 | 6 | 4 | 27 | 59 | 25 |
| 29 | 7 | 3 | 18 | 58 | 30 |
| 30 | 8 | 1 | 19 | 57 | none |
| 31 | 9 | 1 | 18 | 57 | none |
| 32 | 10 | 1 | 23 | 58 | 30 |

The starch-based concentrations reported in the tables for the additive compositions are the weight percentages of the as-obtained additive composition, i.e., as an aqueous solution or dispersion or solid powder, based on the starch as commercial product.

Table 3 shows that the STMP and STPP additive compositions fail to have a positive effect on Lory viscosity and tack. Additive composition 5 (potassium zirconium carbonate) does establish viscosity and gelation point values comparable to those provided by borax, but tack is inadequate.

Comparable tack is achieved by additive compositions 6 and 7, which are based on a combination of potassium zirconium carbonate and sodium trimetaphosphate or, respectively, sodium tripolyphosphate.

The great surprise is the differing behavior of additive compositions 6 versus 8 and 7 versus 9. Additive compositions 6 and 7 are aqueous solutions of KZC and STMP in the former case and KZC and STPP in the latter case, whereas additive compositions 8 and 9 are powder mixtures of KZC and STMP and, respectively, KZC and STPP having the corresponding composition of the solutions. The additive compositions are all within a still acceptable window as regards Lory viscosity and gelation point, but the tack of the powder mixtures is insufficient. Spray drying the aqueous solution of Example 6 gives a powder (additive composition 10) that has virtually the same relative composition as additive composition 6. When tested, this spray-dried product gives the same results as the corresponding solution.

TABLE 4
Influence of additive compositions 1, 6 to 10 from table 2 on
Lory viscosity, gelation point and tack of corn starch glue
SL-2 from table 1.

| | | Concen- | | | |
|---|---|---|---|---|---|
| | Additive | tration | Lory | Gelation | |
| | composition | based on | viscosity | point | Tack at |
| Example | of Example | starch | 2215 (s) | (° C.) | 60° C. (s) |
| 33 | 1 | 1 | 31 | 55 | 15 |
| 34 | 6 | 2 | 20 | 55 | 20 |
| 35 | 7 | 2 | 19 | 55 | 20 |
| 36 | 8 | 2 | 21 | 56 | none |
| 37 | 9 | 2 | 13 | 57 | none |
| 38 | 10 | 0.7 | 19 | 55 | 20 |

Table 4 presents the experimental results for additive compositions 1 and 6 to 10 in the case of wheat starch. The starch glue in Example 33 was prepared using 13.4 g of Starch 1 and 86.2 g of Starch 2 in contradistinction to the general preparative protocol for SL-2, since the Lory viscosity was distinctly below 20 s when the same preparative method was used.

The results of table 3 are also confirmed in the case of wheat starch.

The differing behavior of additive compositions 6 versus 8 and 7 versus 9 was investigated more closely. For this purpose, the hydrolysis of STPP in aqueous solution at 20-25° C. was tracked. The solution used contained 7 wt % of STPP and a KZC content corresponding to 10 wt % of ZrO₂. The levels of the hydrolysis products were determined by ³¹P NMR spectroscopy after the number of days which is reported hereinbelow in table 5. As shown in table 5, the STPP content decreased to 0.4 mol % in the course of 4 days and was no longer detectable thereafter. The ortho-phosphate content rose continuously until it was found to be 100 mol % in the measurement after 150 days.

TABLE 5
Hydrolysis of STPP in the presence of KZC

| | ortho-Phosphate | Pyrophosphate | |
|---|---|---|---|
| Days | (mol %) | (mol %) | STPP (mol %) |
| 0 | 0 | 3.5 | 31 |
| 1 | 19 | 21 | 13 |
| 4 | 33 | 33 | 0.4 |
| 16 | 43 | 28.5 | 0 |
| 150 | 100 | 0 | 0 |

Depending on the composition of the hydrolysis products, the influence of the various sources of phosphate on the usefulness as an additive composition for starch glues was investigated. Table 6 gives an overview of the compositions of the additive compositions where the aqueous solutions contain KZC in an amount corresponding to a ZrO₂ concentration in the additive compositions of 10 wt % in each case and where the molar ratio of CO₃²⁻:Zr is 3.5. The concentrations of the different sources of phosphate in table 6 are reported in weight percent. Example 43 thus corresponds to an additive composition comprising 10 wt % of ZrO₂, 2.62 wt % of NaH₂PO₄ H₂O and 5.4 wt % of Na₂HPO₄. The additive composition 39 was used as-prepared.

TABLE 6
Additive compositions based on various sources of phosphate

| Example | Observation | NaH₂PO₄H₂O | Na₂HPO₄ | Na₄P₂O₇ | STPP |
|---|---|---|---|---|---|
| 39 | aqueous | | | | 7 |
| | solution | | | | |
| 40 | aqueous | 1.54 | 0 | 3.2 | 2.7 |
| | solution | | | | |
| 41 | aqueous | 2.57 | 0 | 5.02 | 0.09 |
| | solution | | | | |
| 42 | aqueous | 2.62 | 0.78 | 4.33 | 0 |
| | solution | | | | |
| 43 | aqueous | 2.62 | 5.4 | 0 | 0 |
| | solution | | | | |

TABLE 7
Influence of additive compositions 39 to 43 from table 6 on Lory
viscosity, gelation point and tack of corn starch glues SL-7, SL-8
and SL-9 from table 1.

| | | Concen- | | | | |
|---|---|---|---|---|---|---|
| | Additive | tration | | | | |
| | compo- | based on | Lory | Gelation | Tack at | |
| | sition of | starch | viscosity | point | 60° C. | Starch |
| Example | Example | (%) | 2215 (s) | (° C.) | (s) | glue |
| 44 | 39 | 2.5 | 10 | 56 | none | SL-7 |
| 45 | 40 | 2.5 | 18 | 57 | 50 | SL-7 |
| 46 | 41 | 2.5 | 19 | 57 | 45 | SL-7 |
| 47 | 42 | 2.5 | 21 | 57 | 45 | SL-7 |
| 48 | 43 | 2.5 | 27 | 57 | 35 | SL-7 |
| 49 | 42 | 1.5 | 33 | 57 | 45 | SL-8 |
| 50 | 42 | 1 | 42 | 57 | 50 | SL-9 |

TABLE 8
Influence of additive compositions 39 to 43 from table 6 on
Lory viscosity, gelation point and tack for starch glue SL-6
from table 1.

| | | Concen- | | | |
|---|---|---|---|---|---|
| | | tration | | | |
| | Additive | based on | Lory | Gelation | |
| | composition | starch | viscosity | point | Tack at |
| Example | of Example | (%) | 2215 (s) | (° C.) | 60° C. (s) |
| 51 | 39 | 1.4 | 10 | 56 | none |
| 52 | 40 | 1.4 | 19 | 57 | 20 |
| 53 | 41 | 1.4 | 21 | 57 | 20 |
| 54 | 42 | 1.4 | 22 | 57 | 20 |
| 55 | 43 | 1.4 | 28 | 57 | 15 |

The ortho-phosphate variant is favored not only in the case of corn starch (Example 48, table 7) but also in the case of Mylbond®210 modified starch (Example 55, table 8).

Comparable results were obtained on replacing the sodium salts of additive compositions 39 to 43 by the corresponding potassium salts such as KH₂PO₄, K₂HPO₄, K₄P₂O₇ and K₅P₃O₁₀.

TABLE 9
Influence of additive compositions 1, 3, 11 to 21 from table 2 on Lory
viscosity, gelation point and tack of corn starch glue SL-1.

| | | Concen- | | | | |
|---|---|---|---|---|---|---|
| | Additive | tration | | | | |
| | compo- | based on | Lory | Gelation | Tack at | Time of |
| Ex- | sition of | starch | viscosity | point | 60° C. | measure- |
| ample | Example | in % | 2215 (s) | (° C.) | (s) | ments |
| 56 | 1 | 1.5 | 21 | 57 | 25 | at once |
| 57 | 1 | 1.5 | 27 | not | 25 | after |
| | | | | determined | | 24 h |
| 58 | 3 | 2 | 10 | 56 | none | at once |
| 59 | 11 | 2.5 | 34 | 57 | none | at once |
| 60 | 12 | 2.5 | 29 | 57 | 25 | at once |
| 61 | 13 | 2.5 | 30 | not | 30 | at once |
| | | | | determined | | |
| 62 | 14 | 3 | 31 | not | none | at once |
| | | | | determined | | |
| 63 | 15 | 2.5 | 21 | 58 | 40 | at once |
| 64 | 16 | 2.5 | 23 | 58 | 40 | at once |
| 65 | 17 | 1.7 | 29 | 55 | 30 | at once |
| 66 | 18 | 1.7 | 26 | 55 | none | at once |
| 67 | 19 | 1.5 | 23 | 55 | 40 | at once |
| 68 | 20 | 0.85 | 25 | 55 | 40 | at once |
| 69 | 21 | 2 | 23 | 58 | 25 | at once |
| 70 | 21 | 2 | 29 | not | 30 | after |
| | | | | determined | | 24 h |

Table 9 shows experimental results for additive compositions comprising potassium aluminate, tartaric acid and dipotassium hydrogenphosphate in addition to a zirconium carbonate and a condensed phosphate. The results again show that at least zirconium carbonates and ortho-phosphates, or a combination of ortho-phosphates and polyphosphates, have to be present for an additive composition of acceptable quality and for values comparable to the prior art (additive composition 1).

TABLE 10
Influence of additive composition 19 from table 2 on Mylbond ® 210 from
Tereos Syral, starch glues SL-3 and SL-4.

| | | | | | | | Tack | |
|---|---|---|---|---|---|---|---|---|
| | | | | | | Lory | after | |
| | Additive | Concen- | | | Tack | 2215 | 24 h | |
| | composition | tration | Lory | Gelation | at | after | at | |
| | of | based on | viscosity | point | 60° C. | 24 h | 60° C. | |
| Example | Example | starch | 2215 (s) | (° C.) | (s) | (s) | (s) | |
| 71 | 2 | 1.4 | 18 | 58 | 25 | 20 | 25 | town water, |
| 72 | 19 | 1.8 | 21 | 56 | 30 | 18 | 30 | SL-3 |
| 73 | 2 | 1.4 | 15 | n.d. | 25 | 17 | 25 | town water |
| 74 | 19 | 2 | 16 | n.d. | 25 | 15 | 30 | and service |
| | | | | | | | | water, SL-4 |

TABLE 11
Influence of additive composition of Example 19
from table 2 on Allstarch CWX 5 from Interstarch
Gesellschaft mbH, starch glue SL-5.

| | Additive | Concen- | | | |
|---|---|---|---|---|---|
| | composition | tration | Lory | Gelation | |
| | of | based | viscosity | point | Tack at |
| Example | Example | on starch | 2215 (s) | (° C.) | 60° C. (s) |
| 75 | none | — | 13 | 56 | >120 |
| 76 | 1 | 1.1 | 23 | 58 | 15 |
| 77 | 19 | 1.5 | 27 | 57 | 20 |

In the case of additive compositions 40 to 43 (see tables 7 and 8), additive composition 19 likewise has a positive effect on the various glue parameters in that comparable values to the prior art (additive compositions 1 and 2) are achieved not only in native starch but also in modified starches. This is demonstrated by table 10 using the example of Mylbond®210 starch from Tereos Syral (starch glues SL-3 and SL-4) and by table 11 using the example of Allstarch CWX-5 starch from Interstarch Gesellschaft mbH (starch glue SL-5).

Table 12 hereinbelow summarizes the additive compositions obtained by mixing an aqueous solution of potassium zirconium carbonate with STMP and the corresponding ligand. The ZrO₂ content of the end products was 5 wt % in each case, the STMP content was 10 wt % in each case and the potassium content was 6.3 wt % in each case. The concentration of the ligands is reported in table 12 as wt %.

After being prepared and allowed to stand for at least 24 hours, the additive compositions were tested in starch glue based on Mylbond®210 starch (table 13).

TABLE 12
Additive compositions with various ligands, ZrO₂: 5 wt %,
STMP: 10 wt %, potassium: 6.3 wt %.

| Example | Observation | Ligand | Concentration |
|---|---|---|---|
| 78 | aqueous solution | none | |
| 79 | aqueous solution | citric acid | 1.9 |
| 80 | aqueous solution | glycine | 2.2 |
| 81 | aqueous solution | DTPMP | 1.7 |
| 82 | aqueous solution | EDTA | 2.2 |
| 83 | aqueous solution | oxalic acid | 1.4 |
| 84 | aqueous solution | sorbitol | 2.4 |
| 85 | aqueous solution | PBTC | 1.6 |
| 86 | aqueous solution | tartaric acid | 2.4 |

TABLE 13
Influence of additive compositions from tables 2 and 12 with
various ligands on starch glue based on Mylbond ®210
starch, SL-3 from table 1.

| | | Concen- | | | |
|---|---|---|---|---|---|
| | Additive | tration | | | |
| | composition | based on | Lory | Gelation | |
| | of | starch | viscosity | point | Tack at |
| Example | Example | in % | 2215 (s) | (° C.) | 60° C. (s) |
| 87 | no stabilizer | 2.5 | 29 | 57 | 30 |
| 88 | 2 | 1.4 | 18 | 58 | 25 |
| 89 | 79 | 2.5 | 28 | 57 | 30 |
| 90 | 80 | 2.5 | 20 | 57 | 30 |
| 91 | 81 | 2.5 | 21 | 56 | 30 |
| 92 | 82 | 2.5 | 25 | 57 | 30 |
| 93 | 83 | 2.5 | 19 | 57 | 30 |
| 94 | 84 | 2.5 | 25 | 57 | 20 |
| 95 | 85 | 2.5 | 27 | 57 | 25 |
| 96 | 86 | 2.5 | 27 | 57 | 25 |

As can be seen in table 13, the choice of ligands offers many possible ways to influence the Lory viscosity and tack of an existing system.

The ligands as stabilizers make it possible to prepare aqueous formulations having a shelf life of more than a year.

### Example 97

250 g of Mylbond®210 were sprayed with 5.36 g of the additive composition of Example 19 (dry matter content 47%), and intimately mixed with the additive composition, under agitation. The starch mixture thus obtained is usable without further treatment.

### Example 98

A starch glue was prepared in accordance with the SL-3 protocol except that Starch 2 and the additive composition were replaced by 76.3 g of the starch mixture of Example 97. The parameters of Lory viscosity, gelation point and tack correspond to those of Example 72 (table 10).

### Example 99

250 g of Mylbond®210 were mixed with 2.68 g of additive composition 20. A starch glue was prepared in accordance with Example 98 except that Starch 2 and the additive composition were replaced by the addition of 75.5 g of the mixture. The parameters of Lory viscosity, gelation point and tack correspond to those of Example 72 (table 10).

### Example 100

250 g of corn starch were sprayed and intimately mixed with 7 g of additive composition 43 under agitation. The starch mixture thus obtained is usable without further treatment.

### Example 101

A starch glue was prepared in accordance with the SL-7 protocol except that Starch 2 and the additive composition were replaced by 138.8 g of the starch mixture of Example 100. The parameters of Lory viscosity, gelation point and tack correspond to those of Example 48 (table 7).

### Example 102

250 g of corn starch were intimately mixed with 0.7 g of finely crushed Na₂HPO₄ and 3.17 g of finely crushed spray-dried KZC (22.1 wt % of ZrO₂, 40 wt % of CO³⁻, 28 wt % of potassium). A starch glue was prepared in accordance with the SL-7 protocol except that Starch 2 and the additive composition were replaced by 137.02 g of the mixture. A tack (60° C.) of 30 s was determined.

Examples listed hereinbelow represent the results with starch glue SL-10. In contradistinction to the previous experiments, the adhesion test was carried out with kraft liner at 70° C.

TABLE 14
Influence of additive compositions 1, 7 and 43 on
Lory viscosity, gelation point and tack in pea
starch glue SL-10.

| | | Concen- | | | |
|---|---|---|---|---|---|
| | Additive | tration | | | |
| | composition | based on | Lory | Gelation | Tack at |
| | of | starch | viscosity | point | 70° C. |
| Example | Example | in % | 2215 (s) | (° C.) | after |
| 103 | 7 | 1.0 | 28 | 62.6 | 35 s |
| 104 | 43 | 1.0 | 27 | 62.4 | 30 s |
| 105 | 1 | 0.5 | 28 | 63.5 | 30 s |

1. A method of using an additive composition in the form of an aqueous solution or dispersion having a solids content ranging from 5 to 75 wt % based on the overall weight of the additive composition, obtainable by a process comprising mixing constituents a) and b) in an aqueous medium wherein
a. is selected from sodium zirconium carbonate, potassium zirconium carbonate, ammonium zirconium carbonate and mixtures thereof,
b. is selected from at least one ortho-phosphate, at least one condensed phosphate, their acids and mixtures,
as additive in starch glue.

2. The method as claimed in claim 1 wherein the additive composition contains an ortho-phosphate.

3. The method as claimed in claim 1 wherein the concentration of zirconium in the additive composition, reckoned as ZrO₂ content, ranges from 0.1 to 30 wt %, preferably from 0.2 to 20 wt %, based on the overall weight of the additive composition.

4. The method as claimed in claim 1 wherein the additive composition comprises a weight ratio of zirconium, reckoned as ZrO₂ content, to said constituent b), reckoned as pure substance, in the range from 0.1 to 20, preferably in the range from 0.2 to 10, more preferably in the range from 0.3 to 5.

5. The method as claimed in claim 1 wherein the aqueous solution or dispersion has a pH above 6, preferably above 8.

6. An additive composition as recited in claim 1 wherein said constituent b) is selected from:
diphosphates, oligophosphates, polyphosphates, metaphosphates and ortho-phosphates and also mixtures thereof.

7. The method as claimed in claim 1 wherein the additive composition contains at least one further constituent selected from the following groups c) to i):
c) hydroxycarboxylic acids, in particular tartaric acid, malic acid, lactic acid, glycolic acid, gluconic acid, citric acid, and/or salts of at least one hydroxycarboxylic acid, in particular sodium salts, potassium salts, ammonium salts, mixtures of the aforementioned hydroxycarboxylic acid(s) and/or their salt(s),
d) di- or polycarboxylic acids other than amino acids and hydroxycarboxylic acids, in particular oxalic acid, maleic acid, malonic acid, succinic acid, itaconic acid and/or salts of the at least one di- or polycarboxylic acid, in particular sodium salts, potassium salts, ammonium salts, mixtures of the aforementioned carboxylic acid(s) and/or their salt(s),
e) amino acids, in particular glycine, glutamic acid, glutamine, aspartic acid, asparagine, ethylenediaminetetraacetic acid, iminodisuccinate, N,N-bis(carboxymethyl)-L-glutamate, N,N-bis(carboxymethyl)alanine sodium salt, N,N-bis(2-hydroxyethyl)glycine and/or salts of the at least one amino acid, in particular sodium salts, potassium salts, ammonium salts, mixtures of the aforementioned amino acid(s) and/or their salt(s),
f) phosphonic acids, in particular phosphonic acid, 1-hydroxyethane-1,1-diphosphonic acid, aminotris(methylenephosphonic acid), 2-phosphonobutane-1,2,4-tricarboxylic acid, diethylenetriaminepenta(methylenephosphonic acid), and/or salts of phosphonic acids, in particular sodium salts, potassium salts, ammonium salts, mixtures of the aforementioned phosphonic acid(s) and/or their salt(s),
g) polyols, in particular ethylene glycol, glycerol, sorbitol, inositol, mono- and disaccharides, such as glucose or sucrose, mixtures thereof,
h) alkanolamines, in particular monoethanolamine, diethanolamine, triethanolamine, mixtures thereof,
i) aluminates, in particular sodium aluminate, potassium aluminate, mixtures thereof comprises and combinations of said further constituents c) to i).

8. The method as claimed in claim 7 wherein the molar ratio of aluminate, reckoned as Al₂O₃ content, to zirconium, reckoned as ZrO₂ content, is in the range from 0 to 10, preferably in the range from 0 to 5, more preferably in the range from 0 to 1.

9. The method as claimed in claim 7 wherein the weight ratio of said one or more further constituents c) to h), reckoned as pure substance, to zirconium, reckoned as ZrO₂ content, is in the range from 0 to 10, preferably in the range from 0 to 5, more preferably in the range from 0 to 3.

10. A method of using an additive composition in solid form, in particular in the form of a powder of an additive composition, as an additive in starch glue.

11. A process for producing an additive composition as recited in claim 1 in the form of an aqueous solution or dispersion having a solids content in the range from 5 to 75 wt %, based on the overall weight of the additive composition, which process comprises mixing at least one constituent a) with at least one constituent b) in an aqueous medium, wherein said constituent
a. is selected from sodium zirconium carbonate, potassium zirconium carbonate, ammonium zirconium carbonate and mixtures thereof,
and said constituent
b. is selected from at least one ortho-phosphate, at least one condensed phosphate, their acids and mixtures.

12. A process for producing an additive composition in the form of a powder of an additive composition, as an additive in starch glue, which process comprises producing an aqueous additive composition as recited in claim 11 and drying the aqueous additive composition or mixing at least one component a) selected from sodium zirconium carbonate, potassium zirconium carbonate, ammonium zirconium carbonate and mixtures thereof with a component b) selected from at least one ortho-phosphate, at least one condensed phosphate, their acids and mixtures.

13. A polysaccharide composition comprising at least one polysaccharide constituent, in the form of starch, modified starch derivatives, dextrins and mixtures thereof and at least one additive composition as recited in claim 1, comprising at least one ortho-phosphate.

14. The polysaccharide composition as claimed in claim 13 wherein the overall amount of constituent a), reckoned as ZrO₂ content, and constituent b), reckoned as pure substance, relative to the polysaccharide constituents is in the range from 0.0002 to 0.05, preferably in the range from 0.0005 to 0.04, more preferably in the range from 0.001 to 0.02.

15. A method of using a polysaccharide composition as defined in claim 13 in the manufacture of starch glue.

16. A method of using a polysaccharide composition as defined in claim 13 in the manufacture of paper, cardboard, paperboard, corrugated fiberboard, paper sleeves.

17. A starch glue comprising a polysaccharide composition as claimed in claim 13.

18. A starch glue comprising the additive composition as recited in claim 1, wherein the overall amount of constituent a), reckoned as ZrO₂ content, and constituent b), reckoned as pure substance, relative to the polysaccharide constituents of the starch glue is in the range from 0.0002 to 0.05, preferably in the range from 0.0005 to 0.04, more preferably in the range from 0.001 to 0.02.

20. A method for using a starch glue as defined in claim 17 in the manufacture of paper, cardboard, paperboard, corrugated fiberboard, paper sleeves.
